(19) United States
(12) Patent Application Publication
(10) Pub. No.: US 2006/0149921 A1
(43) Pub. Date: Jul. 6, 2006

(54) Method and apparatus for sharing control components across multiple processing elements

(76) Inventor: Soon Chieh Lim, Penang (MY)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/022,109

(22) Filed: Dec. 20, 2004

(51) Int. Cl. G06F 15/00

(52) U.S. Cl. 712/10; 712/215

(57) ABSTRACT

Method and apparatus for sharing control components across multiple processing elements. In one embodiment, common control components, including a control store and instruction control unit, are shared across multiple processing cores on a combined microengine. Each processing core includes a respective datapath and register file. Instruction gating logic is employed to selectively forward decoded instructions received from the instruction control unit to the datapaths. The instruction gating logic receives input from predicate stacks used to store control logic corresponding to current conditional blocks of instructions. In response to evaluation of a conditional statement, a logical true or false value is pushed onto a predicate stack based on the result. Upon completing the conditional block, the true/false value is popped off of the predicate stack. This predicate stack mechanism supports nested conditional blocks, and the control sharing mechanisms supports (substantially) concurrent execution of multiple threads on the combined microengine.

### FIELD OF THE INVENTION

The field of invention relates generally to computer networking equipment and, more specifically but not exclusively relates to techniques for sharing control components across multiple processing elements.

### BACKGROUND INFORMATION

Network devices, such as switches and routers, are designed to forward network traffic, in the form of packets, at high line rates. One of the most important considerations for handling network traffic is packet throughput. To accomplish this, special-purpose processors known as network processors have been developed to efficiently process very large numbers of packets per second. In order to process a packet, the network processor (and/or network equipment employing the network processor) needs to extract data from the packet header indicating the destination of the packet, class of service, etc., store the payload data in memory, perform packet classification and queuing operations, determine the next hop for the packet, select an appropriate network port via which to forward the packet, etc. These operations are generally referred to as “packet processing” operations.

Modem network processors perform packet processing using multiple multi-threaded processing elements (e.g., processing cores) (referred to as microengines or compute engines in network processors manufactured by Intel® Corporation, Santa Clara, Calif.), wherein each thread performs a specific task or set of tasks in a pipelined architecture. During packet processing, numerous accesses are performed to move data between various shared resources coupled to and/or provided by a network processor. For example, network processors commonly store packet metadata and the like in static random access memory (SRAM) stores, while storing packets (or packet payload data) in dynamic random access memory (DRAM)-based stores. In addition, a network processor may be coupled to cryptographic processors, hash units, general-purpose processors, and expansion buses, such as the PCI (peripheral component interconnect) and PCI Express bus.

In general, the various packet-processing compute engines of a network processor, as well as other optional processing elements, will function as embedded specific-purpose processors. In contrast to conventional general-purpose processors, the compute engines do not employ an operating system to host applications, but rather directly execute “application” code using a reduced instruction set. For example, the microengines in Intel's IXP2xxx family of network processors are 32-bit RISC processing cores that employ an instruction set including conventional RISC (reduced instruction set computer) instructions with additional features specifically tailored for network processing. Because microengines are not general-purpose processors, many tradeoffs are made to minimize their size and power consumption.

One of the tradeoffs relates to instruction storage space, i.e., space allocated for storing instructions. Since silicon real-estate for network processors is limited and needs to be allocated very efficiently, only a small amount of silicon is reserved for storing instructions. For example, the compute engine control store for an Intel IXP1200 holds 2K instruction words, while the IXP2400 holds 4K instructions words, and the IXP2800 holds 8K instruction words. For the IXP2800, the 8K instruction words take up approximately 30% of the compute engine area for Control Store (CS) memory.

One technique for addressing the foregoing instruction space limitation is to limit the application code to a set of instructions that fits within the Control Store. Under this approach, each CS is loaded with a fixed set of application instructions during processor initialization, while additional or replacement instructions are not allowed to be loaded while a microengine is running. Thus, a given application program is limited in size by the capacity of the corresponding CS memory. In contrast, the requirements for instruction space continue to grow with the advancements provided by each new generation of network processors.

Another approach for increasing instruction space is to employ an instruction cache. Instruction caches are used by conventional general-purpose processors to store recently-accessed code, wherein non-cached instructions are loaded into the cache from an external memory (backing) store (e.g., a DRAM store) when necessary. In general, the size of the instruction space now becomes limited by the size of the backing store. While replacing the Control Store with an instruction cache would provide the largest increase in instruction code space (in view of silicon costs), it would need to overcome many complexity and performance issues. The complexity issues arise mostly due to the multiple program contexts (multiple threads) that execute simultaneously on the compute engines. The primary performance issues with employing a compute engine instruction cache concern the backing store latency and bandwidth, as well as the cache size. In view of this and other considerations, it would be advantageous to provide increased instruction space without significantly impacting other network processor operations and/or provide a mechanism to provide more efficient use of existing control store and associated instruction control hardware.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein like reference numerals refer to like parts throughout the various views unless otherwise specified:

FIG. 1 is a schematic diagram illustrating a technique for processing multiple functions via multiple compute engines using a context pipeline;

FIG. 2 is a schematic diagram illustrating architecture details for a pair of conventional microengines used to perform packet-processing operations;

FIG. 3 is a schematic diagram illustrating architecture details for a combined microengine, according to one embodiment of the invention;

FIG. 4a is a pseudocode listing showing a pair of conditional branches that are handled using conventional branch-handling techniques;

FIG. 4b is a pseudocode listing used to illustrate how conditional branch equivalents are handled using predicate stacks, according to one embodiment of the invention;

FIG. 5a is a schematic diagram illustrating further details of the combined microengine architecture of FIG. 3, and also containing an exemplary code portion that is executed to illustrate handling of conditional branch predicate operations depicted in the following FIGS. 5b-g;

FIG. 5b is a schematic diagram illustrating operations performed during evaluation of a first conditional statement in the code portion, including pushing logic corresponding to condition evaluation results (the resulting predicate or logical result of the evaluation) to respective predicate stacks;

FIG. 5c is a schematic diagram illustrating operations performed during evaluation of a first summation statement, wherein operations corresponding to the statement are allowed to proceed on the left-hand datapath, but are blocked from proceeding on the right-hand datapath;

FIG. 5d is a schematic diagram illustrating popping of the predicate stacks in response to a first “End if” instruction signaling the end of a conditional block;

FIG. 5e is a schematic diagram illustrating operations performed during evaluation of a second conditional statement in the code portion, including pushing logic corresponding to condition evaluation results to respective predicate stacks;

FIG. 5f is a schematic diagram illustrating operations performed during evaluation of a second summation statement, wherein operations corresponding to the statement are allowed to proceed on the right-hand datapath, but are blocked from proceeding on the left-hand datapath;

FIG. 5g is a schematic diagram illustrating popping of the predicate stacks in response to a second “End if” instruction;

FIG. 6a is a schematic diagram illustrating wake-up of a pair of threads that are executed on two conventional microengines;

FIG. 6b is a schematic diagram illustrating wake-up for a pair of similar threads on a combined microengine;

FIG. 7a is a schematic diagram illustrating handling of a conditional block containing a nested conditional block, according to one embodiment of the invention;

FIG. 7b is a schematic diagram analogous to that shown in FIG. 7a, wherein the conditional statement for the nested condition block evaluates to false;

FIG. 8a is a schematic diagram illustrating a pair of microengines executing respective sets of transmit threads that can be replaced with a combined microengine running a single set of the same transmit threads;

FIG. 8b is a schematic diagram illustrating a pair of microengines executing respective sets of transmit and receive threads that can be replaced with a combined microengine running a single set of transmit and receive threads in an alternating manner; and

FIG. 9 is a schematic diagram of a network line card employing a network processor that employs a combination of individual and combined microengines used to execute threads to perform packet-processing operations.

### DETAILED DESCRIPTION

Embodiments of methods and apparatus for sharing control components across multiple processing elements are described herein. In the following description, numerous specific details are set forth, to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

Modem network processors, such as Intel's® IXP2xxx family of network processors, employ multiple multi-threaded processing cores (e.g., microengines) to facilitate line-rate packet processing operations. Some of the operations on packets are well-defined, with minimal interface to other functions or strict order implementation. Examples include update-of-packet-state information, such as the current address of packet data in a DRAM buffer for sequential segments of a packet, updating linked-list pointers while enqueuing/dequeuing for transmit, and policing or marking packets of a connection flow. In these cases the operations can be performed within the predefined-cycle stage budget. In contrast, difficulties may arise in keeping operations on successive packets in strict order and at the same time achieving cycle budget across many stages. A block of code performing this type of functionality is called a context pipe stage.

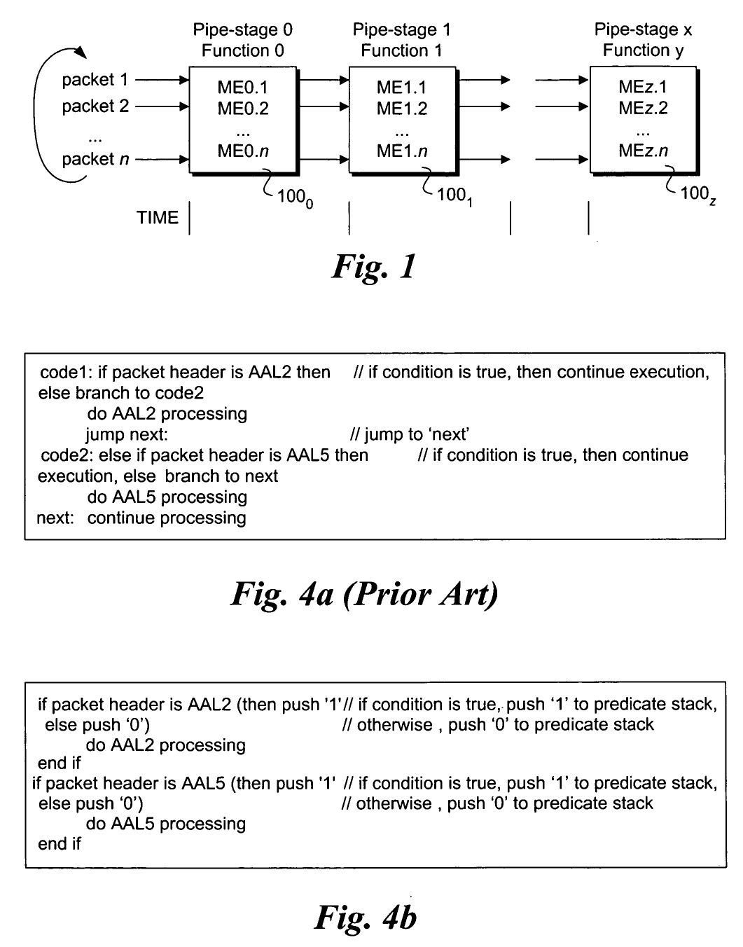

In a context pipeline, different functions are performed on different microengines (MEs) as time progresses, and the packet context is passed between the functions or MEs, as shown in FIG. 1. Under the illustrated configuration, z MEs 100_{0-z} are used for packet processing operations, with each ME running n threads. Each ME constitutes a context pipe stage corresponding to a respective function executed by that ME. Cascading two or more context pipe stages constitutes a context pipeline. The name context pipeline is derived from the observation that it is the context that moves through the pipeline.

Under a context pipeline, each thread in an ME is assigned a packet, and each thread performs the same function but on different packets. As packets arrive, they are assigned to the ME threads in strict order. For example, there are eight threads typically assigned in an Intel IXP2800® ME context pipe stage. Each of the eight packets assigned to the eight threads must complete its first pipe stage within the arrival rate of all eight packets. Under the nomenclature illustrated in FIG. 1, MEi.j, i corresponds to the ith ME number, while j corresponds to the jth thread running on the ith ME.

A more advanced context pipelining technique employs interleaved phased piping. This technique interleaves multiple packets on the same thread, spaced eight packets apart. An example would be ME0.1 completing pipe-stage 0 work on packet 1, while starting pipe-stage 0 work on packet 9. Similarly, ME0.2 would be working on packet 2 and 10. In effect, 16 packets would be processed in a pipe stage at one time. Pipe-stage 0 must still advance every 8-packet arrival rates. The advantage of interleaving is that memory latency is covered by a complete 8 packet arrival rate.

Under a functional pipeline, the context remains with an ME while different functions are performed on the packet as time progresses. The ME execution time is divided into n pipe stages, and each pipe stage performs a different function. As with the context pipeline, packets are assigned to the ME threads in strict order. There is little benefit to dividing a single ME execution time into functional pipe stages. The real benefit comes from having more than one ME execute the same functional pipeline in parallel.

In accordance with aspects of the embodiments discussed below, techniques are disclosed for sharing control components across multiple processing cores. More specifically, these exemplary embodiments illustrate techniques for sharing control components across multiple microengines, wherein execution of context pipelines and functional pipelines are enabled in a manner to that currently employed using conventional “stand-alone” microengines. In order to better understand and appreciate aspects of these embodiments, a discussion of the operations of a pair of conventional microengines is not provided.

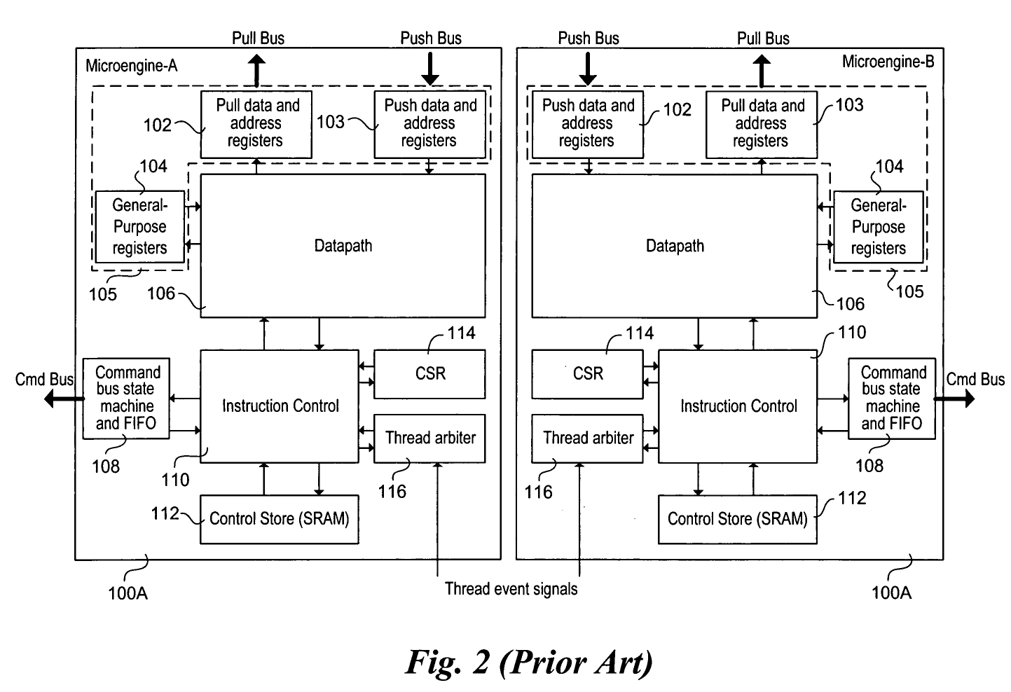

A conventional configuration for a pair of microengines is shown in FIG. 2. Each of Microengines 100A and 100B have an identical configuration, including pull data and address registers 102, push data and address registers 103, general-purpose registers 104, a datapath 106, a command bus state machine and FIFO (first-in, first-out) 108, an instruction control 110 unit, which loads instructions from a control store 112, control and status registers (CSR) 114, and a thread arbiter 116. The pull data and address registers 102, the push data and address registers 104, and general-purpose registers are logically included in a register file 105.

Under the conventional approach, each of microengines 100A and 100B independently execute separate threads of instructions via their respective datapaths, wherein the instructions are typically loaded into their respective control stores 112 during network processor initialization and then loaded into instruction control unit 110 in response to appropriate code instructions. As used herein a “datapath” comprises a processing core's internal data bus and functional units; for simplicity and clarity, datapath components are depicted herein as datapath blocks or arithmetic logic units (part of the datapath). Although the code on each of microengines 100A and 100B executes independently, there may be instances in which the execution threads and correspond code are sequenced so as to perform synchronized operations during packet processing using one of the pipelined approaches discussed above. However, there is still a requirement for separate instruction controls 110, control stores 112, and thread arbiters 116.

The use of the pull and push buses is to enable data “produced” by one ME (e.g., in connection with one context pipeline thread or functional stage) to be made available to the next ME in the pipeline. In this manner, the processing context can be passed between MEs very efficiently, with a minimum amount of buffering.

In accordance with aspects of embodiments described below, a scheme for sharing control components via a “combined” microengine architecture is disclosed. The architecture replicates certain microengine elements described above with reference to the conventional microengine configuration of FIG. 2, while sharing control-related components, including a control store, instruction control, and thread arbiter. The architecture also introduces the use of predicate stacks, which are used to temporarily store information related to instruction execution control in view of conditional (predicate) events.

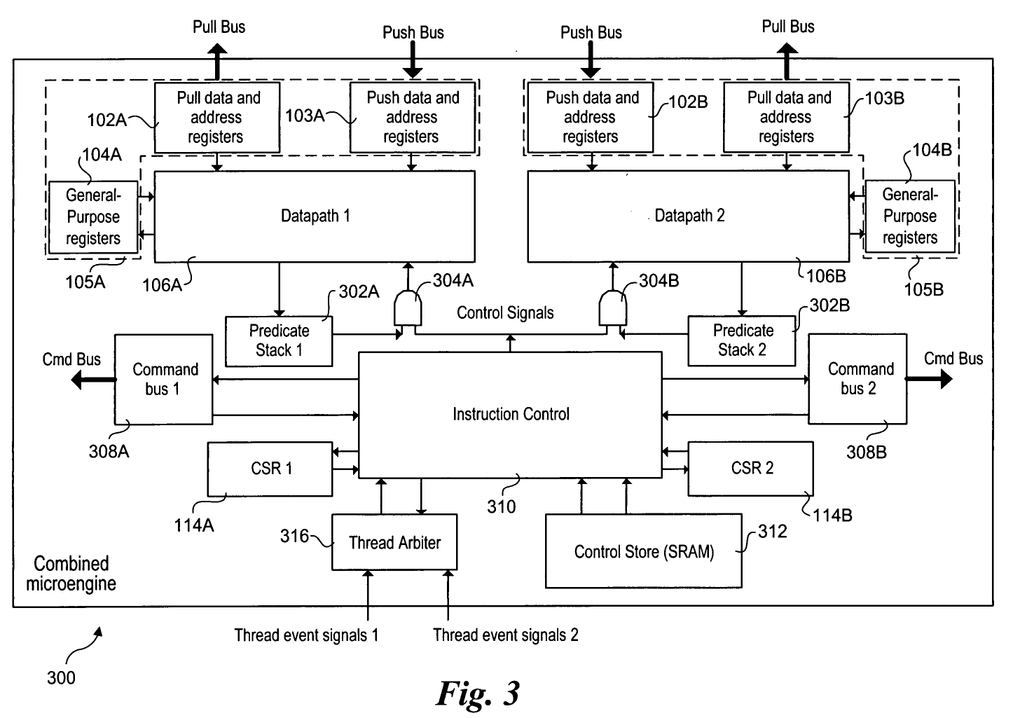

Architecture details for one embodiment of a combined microengine 300 are shown in FIG. 3. The architecture includes several replicated components that are similar to like-numbered components shown in FIG. 2 and discussed above. For clarity, an “A” or “B” is appended to each of the replicated components to distinguish these components from one-another; however, each pair of components share similar structures and perform similar functions. The replicated components include pull data and address registers 102A and 102B, push data and address registers 103A and 103B, general-purpose registers 104A and 104B, datapaths 106A and 106B, and CSRs 114A and 114B. The push/pull data and address registers, as well as the general-purpose registers are logically combined as registers files 105A and 105B. Combined microengine 300 also includes a pair of command bus controller 308A and 308B. These command bus controllers are somewhat analogous to command bus state machine and FIFOs 108, although they function differently in view of control operations via predicate stacks, as described below.

Combined microengine 300 further includes replicated components that are not present in the conventional microengine architecture of FIG. 2. These components include predicate stacks 302A and 302B, and instruction gate logic 304A and 304B.

As discussed above, the combined microengine architecture includes control components that are shared across the sets of replicated components. These include an instruction control unit 310, a control store 312, and a thread arbiter 316. The shared instruction control unit, which is used to decode instructions and implement the instruction pipeline, now decodes a single stream of instructions from control store 312, and generates a single set of control signals (read/write enables, operand selects, etc.) to both datapaths 106A and 106B.

A single code stream and single instruction pipeline does not imply that the two datapaths execute the same sequence of instructions. The two datapaths can still execute different instructions based on different contexts. However, conventional ‘branch’ instructions are not used to perform execution of conditional code segments for the datapaths. Instead, conditional statements are evaluated to push appropriate control logic into predicate stacks 302A and 302B, which are then used to selectively control execution of instructions (corresponding to the condition) along the appropriate datapath(s). A predicate stack is a stack that is pushed with the evaluated result (the predicate) during a conditional statement, and is popped when the conditional block ends. In addition, the predicate stacks gate the control signals going into the datapaths via instruction gating logic 304A and 304B.

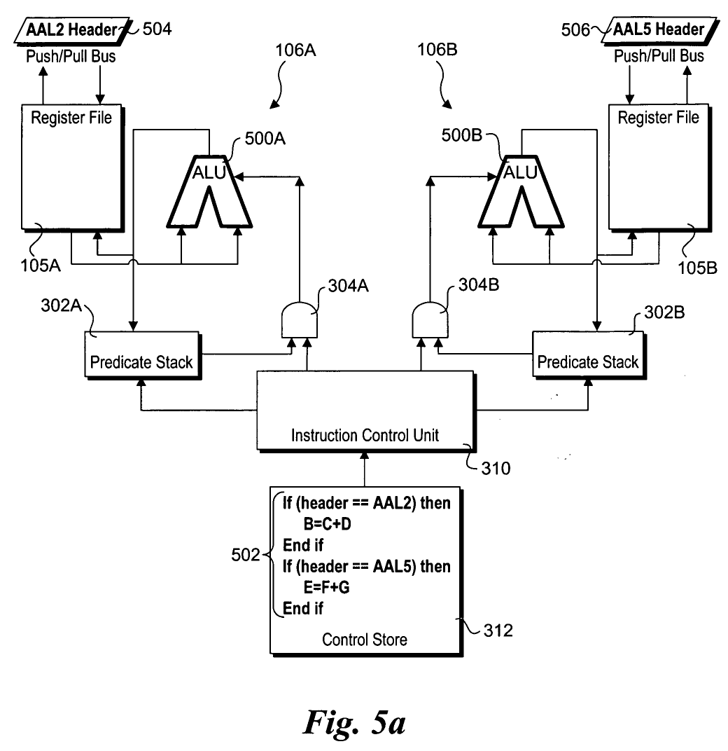

In order to better understand the operation of predicate stacks in the context of the combined microengine architecture of FIG. 3, a comparison between the form and execution of a conventional conditional code segment and handling an analogous conditional code segment using predicate stacks is illustrated in FIGS. 4a and 4b. For example, FIG. 4a shows an exemplary portion of pseudocode including two conventional conditional branch statements, identified by labels “code1:” and “code2:”. In accordance with conventional practice, a first set of instructions (illustrated by AAL2 (ATM (asynchronous transfer mode) adaptation layer 2) processing) is performed if the conditional branch statement at label “code1:” is true. Upon completion of AAL2 processing the instruction sequence is jumped to the “next:” label, whereupon processing is continued at that statement. If the “code:1” conditional branch statement is false, processing branches to the conditional branch statement at label “code:2” If this conditional branch statement is true, a second set of instructions (illustrated by AAL5 (ATM adaptation layer 5) processing) is performed, and execution continues at the “next:” label. If the “code2:” conditional branch statement is false, the execution sequence is jumped to the “next:” label.

Rather than employ conventional branching, embodiments of the invention employ the predicate stacks to control selective processing of instructions via datapaths 106A and 106B. An exemplary set of pseudocode illustrating the corresponding programming technique is shown in FIG. 4b. The first conditional statement is used to determine whether the predicate condition (packet header is AAL2 in this instance) is true or false. If it is true, a logical value of ‘1’ (the predicate bit) is pushed on the predicate stack; otherwise, a logical value of ‘0’ is pushed on the stack, indicating the predicate is false. The push operations illustrated in FIG. 4b are shown in parenthesis because they are implicit operations rather than explicit instructions, as described below. The AAL2 processing is then performed to completion along an appropriate datapath. As will be illustrated below, this involves loading and decoding the same instructions for both datapaths, with the results of the instruction execution for an “inactive” (i.e., inappropriate) datapath (e.g., one having a value of ‘0’ pushed to its predicate stack) being nullified. At the conclusion of the first “end if” statement, both predicate stacks are popped, so they are now empty.

During evaluation of the second conditional statement (if packet header is AAL5), the predicate stacks are again pushed with a ‘1’ or ‘0’ in view of the result of the condition evaluation. This time, AAL5 processing is performed to completion using a datapath whose predicate stack contains a ‘1’ value. As before, execution of instructions for a datapath having a predicate stack loaded with ‘0’ is nullified. Both predicate stacks are then popped in response to the second “end if” statement.

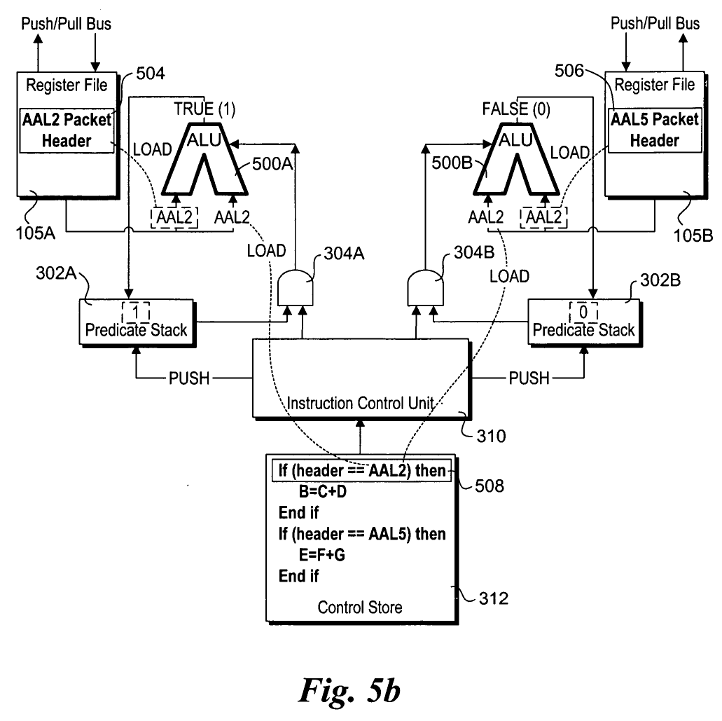

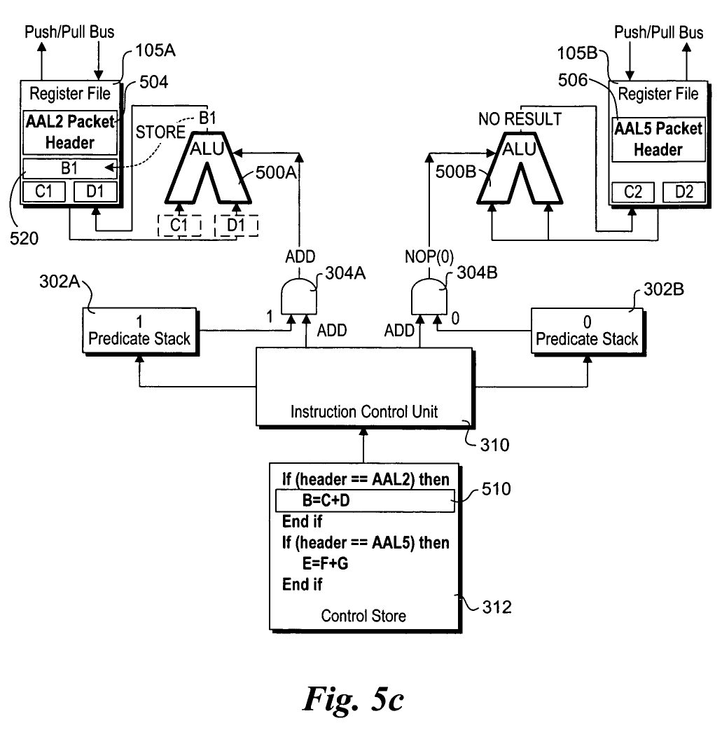

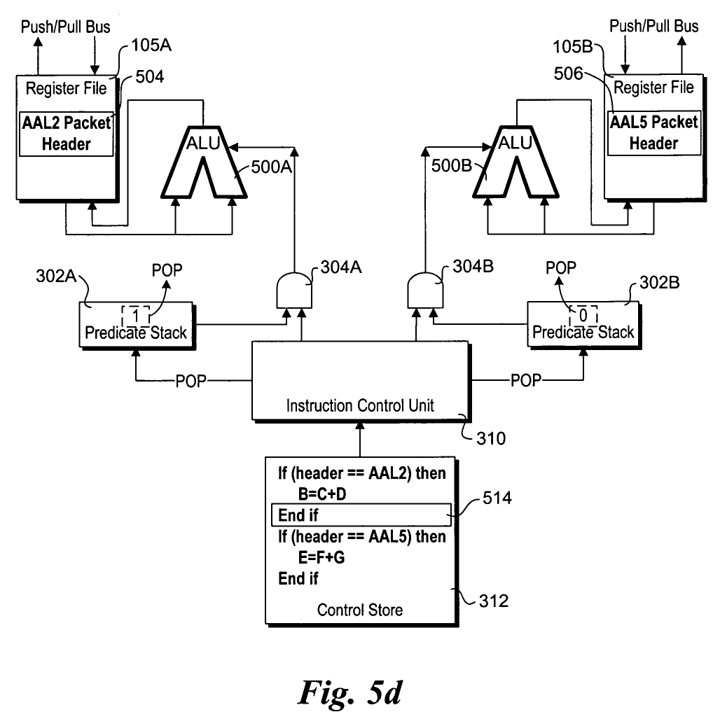

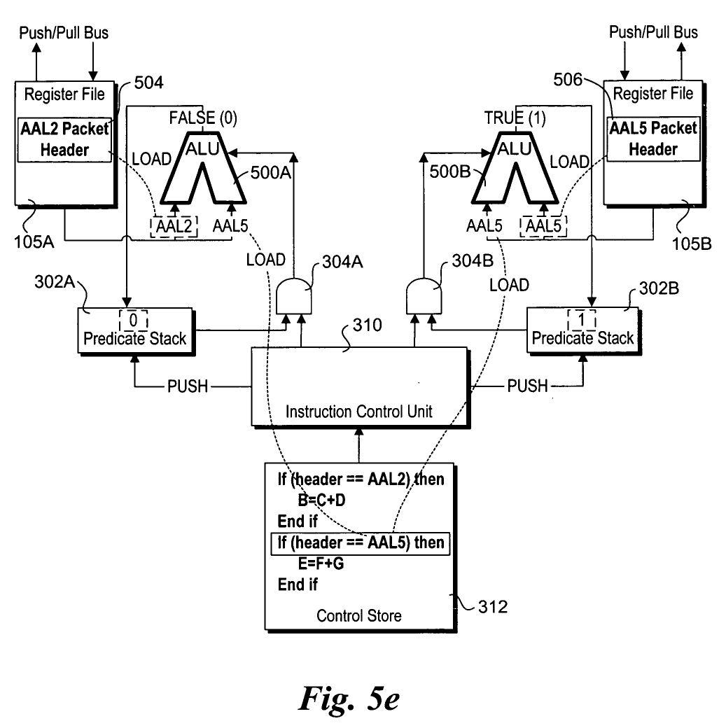

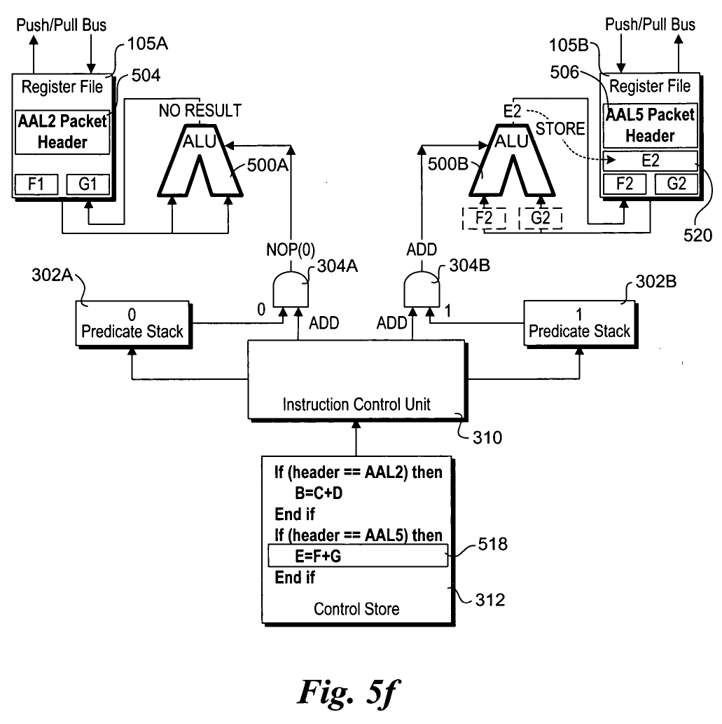

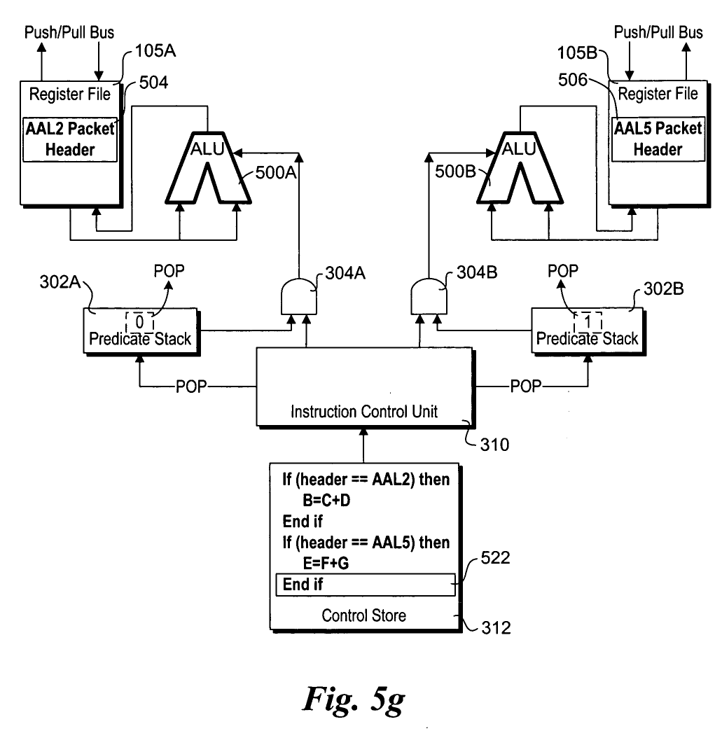

As presented in FIG. 4b and illustrated in FIGS. 5a-g below, pseudocode is used to more clearly describe handling processing of conditional blocks with predicate stacks. It will be recognized by those skilled in the art that the actual code being processed by the illustrated hardware will comprise machine code, which for microengines is commonly referred to a “microcode”. The microcode is derived from compilation of a higher-level language, such as, but not limited to, the C programming language. While the C programming language includes constructs for providing conditional branching and associated logic, the compiled microcode will not contain the same constructs. For example, C supports “If . . . End if” logical constructs, while the corresponding compiled microcode that is produced does not. Instead, the microcode will include a combination of operational code (op codes) and operands (data on which the op codes operate). It will further be recognized that the instruction set for the processing cores on which the microcode is to be executed will include op codes that are used for triggering the start and end of conditional blocks.

An event sequence illustrating handling of conditional blocks using predicate stacks is illustrated in FIGS. 5a-g, which contain further details of combined microengine architecture 300 along with exemplary data loaded in register files and predicate stacks. As shown in FIG. 5a, each of datapaths 106A and 106B include a respective arithmetic logic unit (ALU) 500A and 500B that receives input operands from respective register files 105A and 105B. Each of ALUs 500A and 500B also receives a control input (e.g., a signal to load execute a loaded op code) from the output of respective instruction gating logic 304A and 304B. The output of each ALU (e.g., a binary value) is selectively returned to its respective predicate stack or register file based on the context of the current operation. In one embodiment, the predicate stack is implemented as a register, with the output of the ALU being directed to be pushed onto the predicate stack (e.g., added to the register) via applicable control signals provided by instruction control unit 310. In one embodiment the register comprises a rollover registers, wherein pushing the stack causes existing bits to be shifted to the left to make room for the new bit being pushed onto the stack, and popping that stack causes existing bits to be shifted to the right, thus popping the least significant bit off of the stack.

To further illustrate how the predicate stacks and other components are used to handle execution of predicate code segments, processing of an exemplary code portion 502 including conditional blocks 503 and 504 is described in connection with FIGS. 5a-g. At the beginning of the process, code portion 502 is stored in control store 312, with each instruction (as applicable) in the code being loaded into instruction control unit 310 and decoded based on the code sequence logic. Operands for the decoded instructions are then loaded into the appropriate register file registers. In one embodiment, the operands are loaded into general-purpose registers that are analogous to general-purpose registers 104A and 104B. It is noted that the register files may contain different sets of general-purpose registers, depending on the requirements of targeted applications. In addition, the operations provided by the general-purpose registers discussed herein may also be implemented by specific-purpose registers using well-known techniques common to the processing arts.

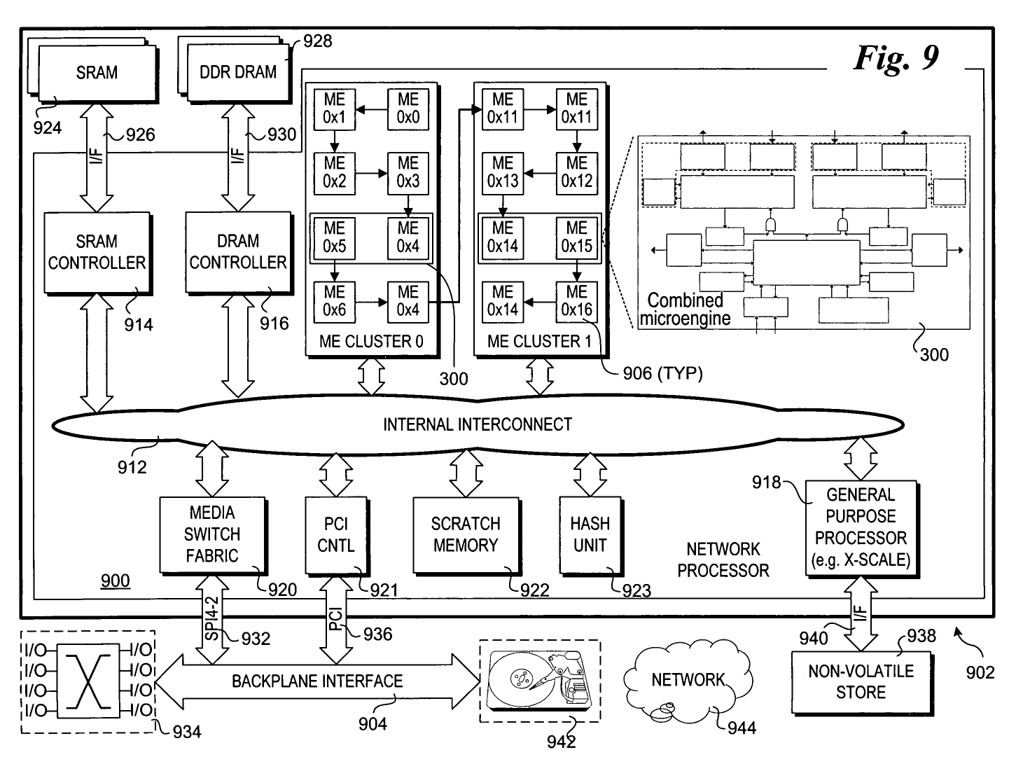

Prior to the first conditional statement in code portion 502, it is presumed that an AAL2 Header has been forwarded to the push/pull bus for register file 105A, while an AAL5 header has been forwarded to the push/pull bus for register file 105B. Under typical packet processing of ATM cells, the headers for the cells (in this instance, AAL2 and AAL5 headers) are extracted and employed for “fast path” processing in the data plane, while the packet payload data in the cells is typically parsed out and stored in slower memory, such as bulk DRAM. The ATM Adaptation Layer (AAL) is designed to support different types of applications and different types of traffic, such as voice, video, imagery, and data. Since the AAL2 and AAL5 headers contain the relevant packet-processing information, only the headers need be employed for subsequent packet processing operations. (It is noted that header information in higher layers may also be used for packet-processing operations.) In the context of the foregoing pipelined-processing schemes, the operations of extracting the AAL2 and AAL5 packet headers and providing the headers to the push/pull buses for register files 105A and 105B may be performed by other microengines or other processing elements in the network processor or line card, such as shown in FIG. 9 and discussed below.

As shown in FIG. 5b, AAL2 Packet header 505 has been loaded into register file 105A via its push/pull bus, AAL5 Packet header 506 has been loaded into register file 105B via its push/pull bus. For example, predetermined fields for these packet headers may be loaded into respective general-purpose registers. At this point, processing of the instructions in code portion 502 commences. This begins with the evaluation of the first conditional statement 508, “If (header==AAL2) then”, in conditional block 503. In the context of the present embodiment, along with the architecture of FIGS. 5a-g, the operation of the predicate stacks are implied by the programming code structure. That is, there are no explicit instructions (added to the known triggering op codes) to cause the predicate stacks to be pushed with a ‘1’ or ‘0’. Rather, this operation is automatically performed by the underlying hardware in view of the result of a conditional statement via processing of corresponding op codes.

As shown proximate to ALUs 500A and 500B in FIG. 5a, the result of decoding conditional statement 508 is to provide an “AAL2” value as one of the inputs to each of the ALUs. Meanwhile, the other ALU inputs are data identifying the header types for the packet headers stored in the respective registers files 105A and 105B. In this instance, the second input for ALU 500A is “AAL2”, while the second input for ALU 500B is “AAL5”. (It is noted that in practice, the AAL2 and AAL5 header values would actually comprise binary numbers extracted from the portion of the headers identifying the corresponding AAL cell type; the use of “AAL2” and “AAL5” labels are used herein for convenience and clarity.)

In response to their inputs, ALU 500A outputs a logical ‘1’ value (True), while ALU 500B outputs a logical ‘0’ value (False). Respectively, this indicates that the packet header type in register file 105A is an AAL2 packet header, while the packet header type in register file 105B is not an AAL2 packet header. As a result, a ‘1’ is pushed on predicate stack 302A, while a ‘0’ is pushed onto predicate stack 302B, as shown in FIG. 5c. In one embodiment, respective “PUSH” signals (e.g., tri-stage logic-level signals) are provided from instruction control unit 310 as inputs to each of predicate stacks 302A and 302B to cause corresponding buffers or registers in the predicate stacks to receive and store the respective outputs of ALUs 500A and 500B.

Continuing at FIG. 5c, the next instruction to be evaluated is an arithmetic instruction 510. In this example, an exemplary addition instruction is used (B=C+D). The processing of this instruction illustrated in FIG. 5c is used to show how execution of an exemplary set of instructions that are to be executed when a conditional statement is true, such as packet-processing operations for an AAL2 packet, would be performed. This instruction (or set of instructions that might be employed for one or more conditional packet-processing operations) is/are referred to as the conditional block instructions—that is, the instructions to be executed if a condition (the predicate) is true.

Decoding of instruction 510 causes respective instances of the instruction operands C and D to be loaded into respective registers in register files 105A and 105B. For clarity, these instances are depicted as values C1 and D1 for register file 105A, and C2 and D2 for register file 105B; in practice, each register file would be loaded with the same values for C and D.

Instruction decoding by instruction control unit 310 further provides an “existing” instruction (ADD in this case) as one of the inputs to instruction gating logic 304A and 304B. Instruction gating logic 304A and 304B, in combination with control signals provided by instruction control unit 306, cause the op code of the current instruction to be loaded into an appropriate ALU op code register if their predicate stack input is a ‘1’, and a NOP (No Operation) if their other predicate stack input is a ‘0’. For simplicity, the instruction control units 304A and 304B are depicted as AND gates, with an op code as one of the inputs. In practice, this input is a logic signal indicating that an op code is to be loaded into each ALUs op code register.

As a result of processing their respective input op codes in view of their input operands (stored in appropriate ALU operand registers), ALU 500A outputs a value B1, which is the sum of operands C1 and D1, while ALU 500B outputs no result in response to its NOP input instruction. The output of ALU 500A is then stored in one or the registers for register file 105A, as depicted by a register 512.

In an actual packet-processing sequence, one or more operations would be performed on packet header data received at the push bus for a given register file. The intermediate results of the processing would be stored in scratch registers (e.g., general-purpose registers) or the like for the register files, as is performed during conventional microengine operations. The overall result of the processing would then typically be provided to the pull data (or address) registers and/or “next neighbor” registers (part of the register file in one embodiment, but not shown herein).

Moving to FIG. 5d, this figure illustrates the state of the combined microengine components upon evaluation of an “End if” instruction 514. As discussed above, evaluation of an “End if” instruction (actually the corresponding op code that the compiler generates) causes both predicate stacks to be popped, thus clearing the values for both predicate stacks. In one embodiment, a “POP” logic-level signal is provided from instruction control unit 310 to predicate stacks 302A and 302B to flush the current values in the predicate stack buffers or registers (as applicable). For clarity, the values for the registers in register files 105A and 105B are also shown as being cleared in FIG. 5d. In practice, the most-recently loaded values will continue to be stored in these registers until the next operand values are loaded.

Evaluation and processing of the next three instructions (516, 518, and 522), depicted at FIGS. 5e, 5f, and 5g, respectively, are analogous to the evaluation and processing of similar instructions 508, 510, and 514 discussed above. However, in this case, the applicable “active” datapath is ALU 500B, while operations on ALU 500B are nullified. For example, evaluation of the conditional statement 516 will result in a ‘1’ (True) value being output from ALU 500B and pushed onto predicate stack 302B, while the output of ALU 500A will be a ‘0’ (False), which is pushed onto predicate stack 302A.

Continuing at FIG. 5f, this figure illustrates the evaluation of an arithmetic instruction 518, which is an addition (ADD) instruction that is analogous to instruction 510 above. As before, this instruction is merely illustrative of packet-processing operations that could be performed while predicate stack 302B is loaded with a ‘1’ and predicate stack 302A is loaded with a ‘0’ in response to evaluation of conditional statement 516. Also as before, this results in decoded instruction op codes being allowed to proceed to execution along the “active” datapath (e.g., ALU 500B), while only NOPs are provided to the ALU (500A) along the “non-active” or nullified datapath (e.g., ALU 500A).

Thus, the process begins by decoding instruction 518 and loading instances of operands F and G into appropriate registers in each of register files 105A and 105B, as depicted by operand instances F1 and G1 for register file 105A, and operand instances F2 and G2 for register file 105B. The decoded ADD instruction op code is then provided as inputs to each of instruction gating logic 304A and 304B. Since the second input from instruction gating logic 304B is a ‘1’, an ADD instruction op code is provided to ALU 500B, which causes the ALU to sum the F2 and G2 values that are loaded into its input operand registers to yield an output value of E2. This value is then stored in a register 520.

Upon completion of the second conditional block instructions (e.g., instruction 518 in the present example), the instruction sequence will proceed to a second “End if” instruction 522, as depicted in FIG. 5g. As before, evaluation of an op code corresponding to an “End if” instruction causes both of predicate stacks 302A and 302B to be popped, clearing the predicate stacks.

For illustrative purposes, the foregoing examples concerned execution of only a single thread instance on combined microengine 300. However, it will be understood that similar operations corresponding to load and execution of other instruction thread instances may be performed (substantially) concurrently on each of the combined microengine, as is common with conventional microengines.

As an analogy, during ongoing operations, each of conventional microengines 100A and 100B may execute multiple instruction threads corresponding to the instructions stored in their respective control stores 112. The execution of multiple threads is enabled via hardware multithreading, wherein a respective context for each thread is maintained throughout execution of that thread. This is in contrast to the more common type of software-based multithreading provided by modern operating systems, wherein the context of multiple threads is switched using time-slicing, and thus (technically) only one thread is actually executing during each (20-30 millisecond) time slice, with the other threads being idle.

In general, hardware multithreading is enabled by providing a set of context registers for each thread. These registers include a program counter (e.g., instruction pointer) for each thread, as well as other registers that are used to store temporal data, such as instruction op codes, operands, etc. However, an independent control store is not provided for each thread. Rather, the instructions for each thread instance are stored in a single control store. This is enabled by having each thread executing instructions at a different location in the sequence of instructions (for the thread) at any given point in time, while having only one thread “active” (technically, at a finite sub-millisecond time-slice) at a time. Furthermore, under a typical pipelined processing scheme, the execution of various packet-processing functions are staged, and the function latency (e.g., amount of time to complete the function) corresponding to a given instruction thread is predictable. Thus, the “spacing” between threads running on a given compute engine stays substantially even, preventing situations under which different hardware threads attempt to access the same instruction at the same time.

Similar support for concurrent execution of multiple threads is provided by combined microengine 300. This is supported, in part, by providing an adequate amount of register space to maintain context data for each thread instance. Furthermore, to support multiple threads, the wake-up signal events of a thread are a combination of two different signal events, rather than the individual signal events used for conventional microengines.

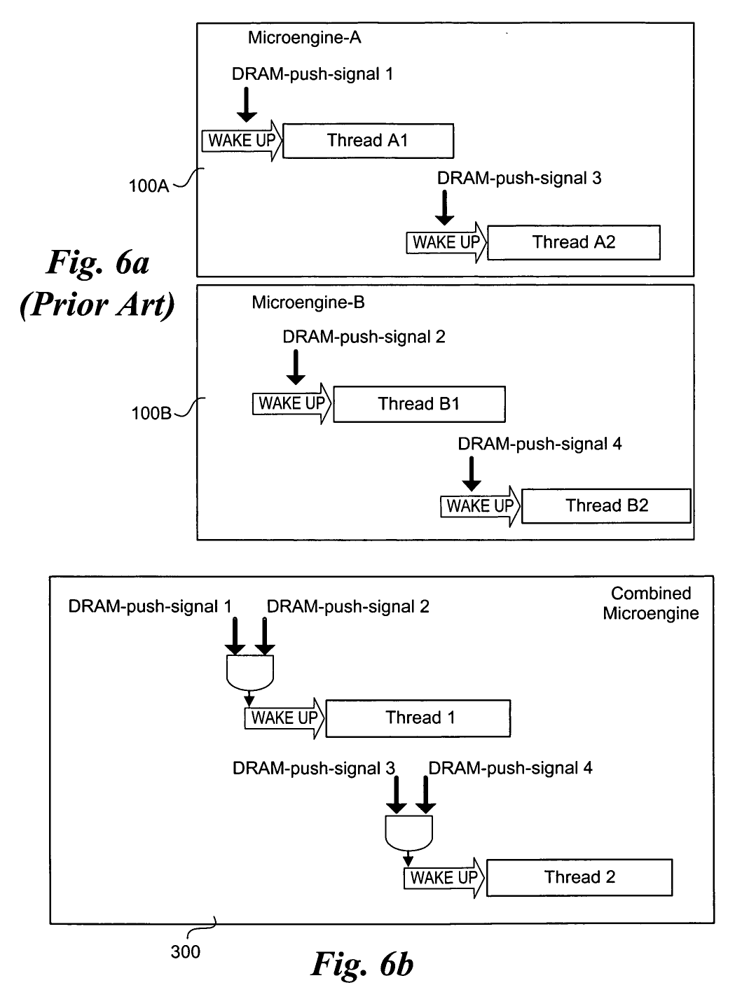

For example, FIG. 6a shows an example of a conventional thread execution using two microengines 100A and 100B (assuming 2 threads per microengine). In this example, the wake-up event is a DRAM push data event (e.g., read DRAM data). In response to such an event, an appropriate thread is awaken, and resumes execution.

FIG. 6b shows one embodiment of a scheme that supports concurrent execution of two threads on a combined microengine 300. Instead of having two separate threads for each microengine, we now have a single set of (2) threads for combined microengine 300. FIG. 6b further illustrates that a thread wakes up when both wake-up events are true.

Although there are only 2 threads running in combined microengine 300, the throughput may be roughly the same as four threads (combined) running on microengines 100A and 100B because each thread runs two datapaths. For instance, it might appear that the time to execute the example code portion in FIG. 4b in a combined microengine would be approximately twice as long as running equivalent conventional code shown in FIG. 4a on two separate microengines. However, there are often overlapping or common codes for different packet-processing functions, which can be combined for efficiency using the combined microengine architecture.

Another feature provided by the predicate stacks and corresponding instruction gating logic is the ability to support nested conditional blocks. In this instance, every time a conditional statement is evaluated, the resulting predicate bit value (true or false) is pushed onto the predicate stack. Thus, with each level of nesting, another bit value is added to the predicate stack. The bit values in the predicate stack are then logically ANDed to generate the predicate stack output logic level, which is ANDed with the control signal from the control unit.

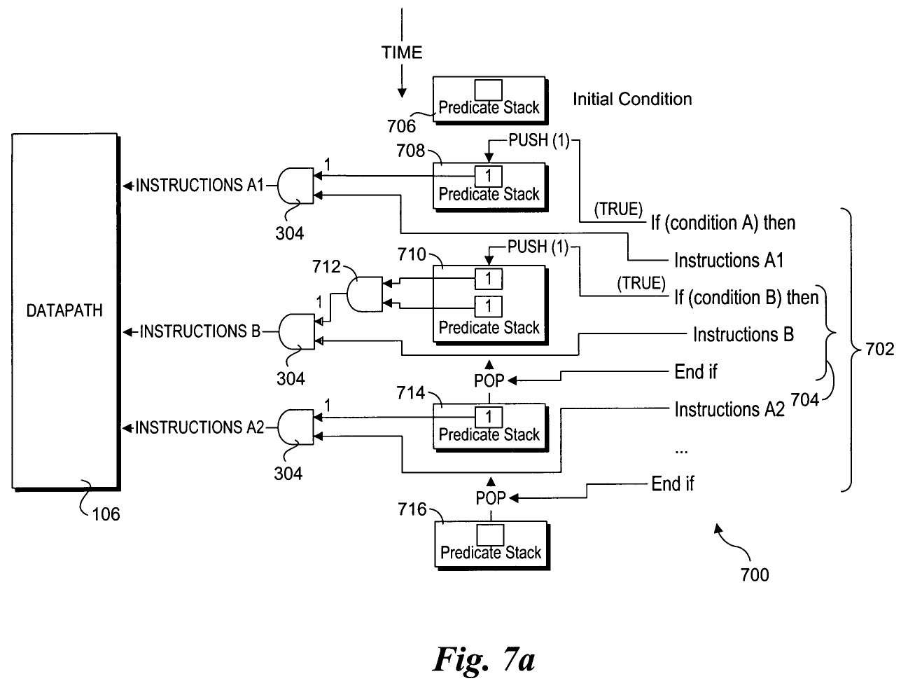

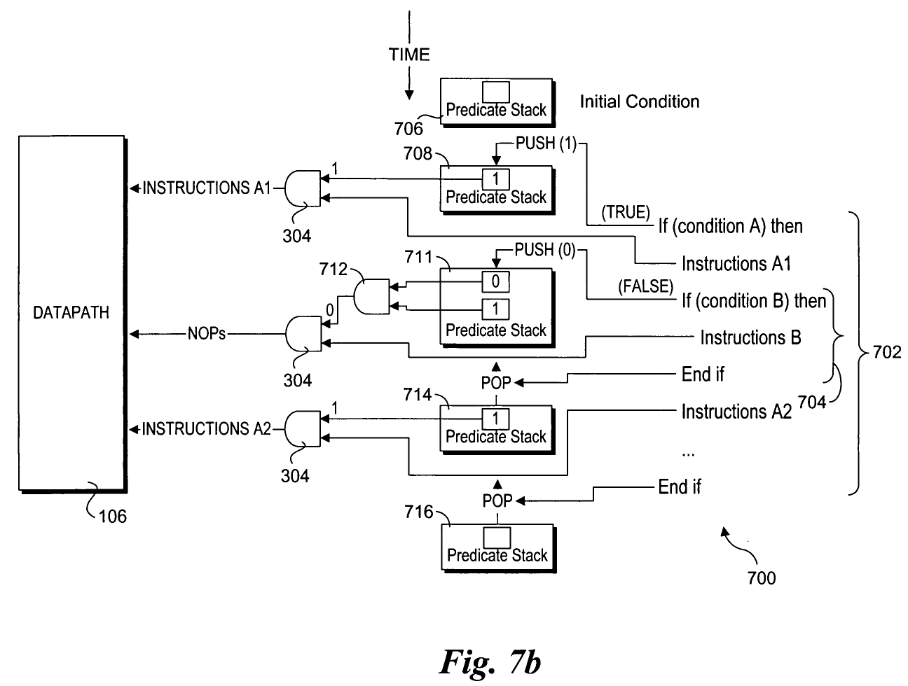

Handling of nested conditional blocks corresponding to an exemplary set of instructions 700 is shown in FIGS. 7a and 7b. Instructions 700 include an outside conditional block 702 that contains a nested (inside) conditional block 704. The schematic diagram illustrates the state of a predicate stack in response to evaluating the various statements and instructions in conditional blocks 702 and 704. In general, the nesting scheme of FIGS. 7a and 7b can be extended to handle any number of nested conditional blocks in a similar manner, with the number only being limited by the maximum size of the predicate stack and corresponding ANDing logic.

The process begins at an initial condition corresponding to a predicate stack state 706, wherein the predicate stack is empty. In response to an affirmative evaluation of the first conditional statement “If (conditional A)” is True, a logic bit ‘1’ is pushed onto the predicate stack, as depicted by a predicate stack state 708. The instructions corresponding to the conditional block are grouped into three sections, including instruction A1 and A2, which are before and after nested conditional block 704. Since the only value in the predicate stack at this time is a ‘1’, instructions A1 are allowed to proceed by instruction gating logic 304 to datapath 106.

Continuing with execution of the code sequence, upon completion of instructions A1 the conditional statement for nested conditional block 704 (“If (Condition B)”) is evaluated. Presuming this condition is also true, a second logical bit ‘1’ is pushed onto the predicate stack, as depicted by predicate stack state 710. In response to decoding instructions B, the bit values in the predicate stack are ANDed, as illustrated by an AND gate 712. The output of this representative AND gate is then provide as the predicate stack input to instruction gate logic 304. Since both bits in the predicate stack are ‘1’s, the output of AND gate 712 is True (1), and instructions B are allowed to proceed to datapath 106.

Suppose that one of the conditional statements in a set of conditional blocks is not affirmed. In this case, it is desired to not forward any instruction in the corresponding conditional block, including any nested conditional blocks, to an inactive datapath. As before, in one embodiment this is enabled by providing NOPs in place of the conditional block in a manner similar to that discussed above with reference to FIGS. 5c and 5f. As shown in FIG. 7b, if the conditional statement for nested conditional block 704 evaluates to False, the second bit pushed on the predicate stack is ‘0’, depicted by a predicate state 711. As a result, the output of AND gate 712 is ‘0’, and NOPs are forwarded to datapath 106.

Upon completion of instructions B, an “End if” instruction identifying the end of nested condition block 704 is encountered. Upon decoding this instruction, a control signal is sent to the predicate stack to pop the stack once, leading to a predicate stack state 714. Next, instructions A2 of the output conditional block 702 are encountered. Since the only bit value in the predicate stack is ‘1’, instructions A2 are permitted by instruction gate logic 304 to proceed to the datapath.

At the conclusion of the execution of instruction A2, an “End if” statement identifying the end of outside conditional block 702 is encountered. In response to decoding this statement, the predicate stack is again popped once, clearing the predicate stack, as depicted by a predicate stack state 716.

Under a typical processor implementation, one or more combined microengines may be mixed with conventional microengines, or all of the microengines may be configured as combined microengines. Furthermore, from the viewpoint of other microengines, the interface components (e.g., register files, push/pull buses, etc.) of the combined microengine appear as two separate microengines. The combined microengine still has two separate microengines identifiers (IDs) allocated to it in a manner that would be employed for separate MEs. Hence, the commands coming out from the two command bus interfaces of the combined ME is still unique to each half of the combined ME, since the commands will be encoded with the corresponding ME ID. The event signals are also unique to each half of the combined microengine. Stall signals from the two Command FIFOs are OR-ed so that anytime one of the command FIFOs is full, the single pipeline is stalled.

Furthermore, unconditional jump and branches are executed in a similar manner to that employed during thread execution in a conventional microengine. In some embodiments, some of the CSRs present in the conventional two-ME architecture of FIG. 2 that are related to the control path may be removed due to redundancy, such as the control store address/data, context CSRs, whereas redundancy of other CSRs related to the datapath (e.g., next neighbor, CRC result, LM address) are maintained to provide separate instances of the relevant data stored in these CSRs.

Embodiments of the invention may be implemented to provide several advantages over conventional microengine implementations to perform similar operations. Notably, by sharing the control components, the area saved is approximately 40-50% of the original conventional microengine size. In addition to size reduction, power consumption may also be reduced. In some embodiments, the saved area or power may then by utilized to add additional microengines for increased performance.

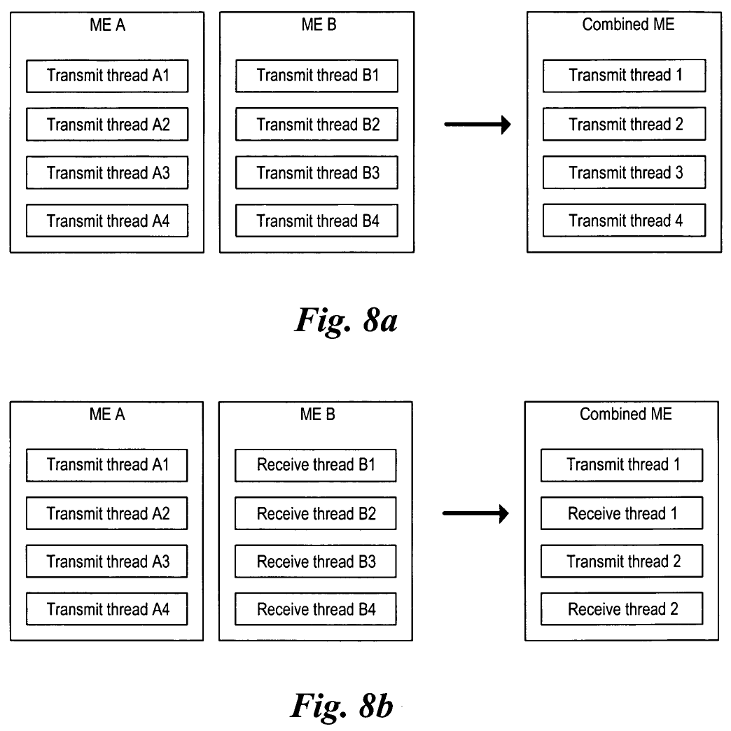

In general, combined microengines may be added to current network processor architectures to offload existing functions or perform new functions. For example, in some applications, two conventional microengines execute threads that perform the same function, e.g. two microengines may perform transmit (where each ME handles different ports), receive, or AAL2 processing operations, such as shown in the left-hand side of in FIG. 8a. This usage is a waste of area and power, since two or more control stores and control units are required (each storing and operating on the same set of code), and hence doubling the switching activity in the two microengines. To overcome wasting such control resources, one or more combined microengines may be implemented to perform a particular function or functions that were previously performed by two or more microengines, such as shown in the right-hand side of FIG. 8a.

Advantages may also be obtained by replacing a pair of microengines that perform different functions with a single combined microengine. For example, in FIG. 8b microengine A executes multiple transmit threads while microengine B executes multiple receive threads. In this situation, the code (instruction sequences) for executing the two functions can be combined and stored in a single control store, with the combined microengine running the different function threads in an alternate fashion.

In addition to the combined microengine 300 architecture shown herein, architectures combining more than two microengines may be implemented in a similar manner. For example, a single set of control components may be shared across four microengines using four predicate stacks and sets of instruction gating logic. As before, the replicated components for each microengine processing core will include a respective datapath, register file, and command bus controller.

FIG. 9 shows an exemplary implementation of a network processor 900 that employs multiple microengines configured as both individual microengines 906 and combined microengines 300. In this implementation, network processor 900 is employed in a line card 902. In general, line card 902 is illustrative of various types of network element line cards employing standardized or proprietary architectures. For example, a typical line card of this type may comprises an Advanced Telecommunications and Computer Architecture (ATCA) modular board that is coupled to a common backplane in an ATCA chassis that may further include other ATCA modular boards. Accordingly the line card includes a set of connectors to meet with mating connectors on the backplane, as illustrated by a backplane interface 904. In general, backplane interface 904 supports various input/output (I/O) communication channels, as well as provides power to line card 902. For simplicity, only selected I/O interfaces are shown in FIG. 9, although it will be understood that other I/O and power input interfaces may also exist.

Network processor 900 includes n logical microengines that are configured as individual microengines 906 or combined microengines 300. In one embodiment, n=8, while in other embodiment n=16, 24, or 32. Other numbers of microengines 906 may also me used. In the illustrated embodiment, 16 microengines 906 are shown grouped into two clusters of 8 microengines, including an ME cluster 0 and an ME cluster 1. Each of ME cluster 0 and ME cluster 1 include six microengines 906 and one combined microengine 300. As discussed above, a combined microengine appears to the other microengines (as well as other network processor components and resources) as two separate microengines, each with its own ME ID. Accordingly, each combined microengine 300 is shown to contain two logical microengines, with corresponding ME IDs.

It is further noted that the particular combination of microengines 906 and combined microengines 300 illustrated in FIG. 9 is merely exemplary. In general, a given microengine cluster may contain from 0 to m/2 combined microengines, wherein m represents the number of logical microengines in the cluster. As another option, the microengines and combined microengines do not need to be configured in clusters. In the embodiment illustrated in FIG. 9, the output from a given microengine or combined microengine is “forwarded” to a next microengine in a manner that supports pipelined operations. Again, this is merely exemplary, as the microengines and combined microengines may be arranged in one of many different configurations.

Each of microengines 906 and combined microengines 300 is connected to other network processor components via sets of bus and control lines referred to as the processor “chassis” or “chassis interconnect”. For clarity, these bus sets and control lines are depicted as an internal interconnect 912. Also connected to the internal interconnect are an SRAM controller 914, a DRAM controller 916, a general-purpose processor 918, a media switch fabric interface 920, a PCI (peripheral component interconnect) controller 921, scratch memory 922, and a hash unit 923. Other components not shown that may be provided by network processor 900 include, but are not limited to, encryption units, a CAP (Control Status Register Access Proxy) unit, and a performance monitor.

The SRAM controller 914 is used to access an external SRAM store 924 via an SRAM interface 926. Similarly, DRAM controller 916 is used to access an external DRAM store 928 via a DRAM interface 930. In one embodiment, DRAM store 928 employs DDR (double data rate) DRAM. In other embodiment DRAM store may employ Rambus DRAM (RDRAM) or reduced-latency DRAM (RLDRAM).

General-purpose processor 918 may be employed for various network processor operations. In one embodiment, control plane operations are facilitated by software executing on general-purpose processor 918, while data plane operations are primarily facilitated by instruction threads executing on microengines 906 and combined microengines 300.

Media switch fabric interface 920 is used to interface with the media switch fabric for the network element in which the line card is installed. In one embodiment, media switch fabric interface 920 employs a System Packet Level Interface 4 Phase 2 (SPI4-2) interface 932. In general, the actual switch fabric may be hosted by one or more separate line cards, or may be built into the chassis backplane. Both of these configurations are illustrated by switch fabric 934.

PCI controller 922 enables the network processor to interface with one or more PCI devices that are coupled to backplane interface 904 via a PCI interface 936. In one embodiment, PCI interface 936 comprises a PCI Express interface.

During initialization, coded instructions (e.g., microcode) to facilitate the packet-processing functions and operations described above are loaded into appropriate control stores for the microengines and combined microengines. In one embodiment, the instructions are loaded from a non-volatile store 938 hosted by line card 902, such as a flash memory device. Other examples of non-volatile stores include read-only memories (ROMs), programmable ROMs (PROMs), and electronically erasable PROMs (EEPROMs). In one embodiment, non-volatile store 938 is accessed by general-purpose processor 918 via an interface 940. In another embodiment, non-volatile store 938 may be accessed via an interface (not shown) coupled to internal interconnect 912.

In addition to loading the instructions from a local (to line card 902) store, instructions may be loaded from an external source. For example, in one embodiment, the instructions are stored on a disk drive 942 hosted by another line card (not shown) or otherwise provided by the network element in which line card 902 is installed. In yet another embodiment, the instructions are downloaded from a remote server or the like via a network 944 as a carrier wave.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the drawings. Rather, the scope of the invention is to be determined entirely by the following claims, which are to be construed in accordance with established doctrines of claim interpretation.

What is claimed is:

1. A method, comprising:
sharing control components across multiple processing cores, the control components including a control store to store instructions and an instruction control unit into which the instructions are loaded and decoded, each processing core including a respective datapath and a respective register file; and
selectively executing instructions in a conditional block via a single datapath, the single datapath determined via an evaluation of a conditional statement contained in the conditional block.

2. The method of claim 1, wherein selectively executing instructions corresponding to a conditional block further comprises:
evaluating a conditional statement provided by instructions loaded from the control store; and
in response thereto, determining a datapath via which instructions related to the conditional statement should be executed in view of evaluation of the conditional statement, the datapath comprising an active datapath; and
executing the instructions via the active datapath.

3. The method of claim 2, further comprising:
employing a mechanism to allow execution of the instructions related to the conditional statement via the active datapath while blocking execution of the instruction along another datapath or other datapaths.

4. The method of claim 3, wherein each of the other datapaths other than the active datapath comprises non-active datapaths, the method further comprising:
providing instruction gating logic for each datapath;
submitting an instruction to the instruction gating logic for each datapath;
allowing, via the instruction gating logic for a datapath, the instruction to proceed along its associated datapath if its datapath is active; otherwise;
providing a NOP (No Operation) instruction to proceed along a non-active datapath.

5. The method of claim 1, further comprising:
maintaining a respective predicate stack for each datapath;
storing information in each predicate stack indicating whether the datapath associated with that predicate stack is currently active or inactive during execution of a set of conditional block instructions; and
enabling or preventing the set of conditional block instructions to be executed along a given datapath based on the information contained in its respective predicate stack.

6. The method of claim 5, further comprising:
pushing a logic value onto a predicate stack in response to evaluation of a conditional statement for a conditional block, the logic value indicating whether a corresponding predicate condition is true or false; and
popping the logic value off of the predicate stack in response to encountering an instruction identifying an end to a conditional block.

7. The method of claim 1, further comprising:
enabling instructions contained in nested conditional blocks to be selectively executed via an appropriate datapath in response to conditional statements contained in the nested conditional blocks.

8. The method of claim 7, further comprising:
maintaining a respective predicate stack for each datapath;
evaluating the conditional statement for each conditional block in a chain of nested conditional blocks;
pushing a logical bit onto a predicate stack in response to each evaluation of each conditional statement in view of data stored in the register file for the datapath associated with that predicate stack, the logical bit indicating whether a result of the conditional statement is true or false; and
logically ANDing the logical bits on a predicate stack to determine whether to permit execution of instructions in a nested conditional block via the datapath associated with that predicate stack.

9. The method of claim 1, further comprising:
employing a shared thread arbiter to arbitrate concurrent execution of multiple threads of instructions via the multiple processing cores.

10. The method of claim 1, further comprising:
loading an instruction from the control store into the instruction control unit, the instruction referencing first and second operands;
decoding the instruction to extract the first and second operands; and
loading a respective instance of the first and second operand into a respective pair of registers for each of the register files.

11. The method of claim 1, wherein the multiple processing cores comprise first and second compute engines configured as a combined compute engine on a network processor.

12. The method of claim 11, further comprising:
forwarding one of a packet or cell header to a register file for a processing core;
evaluating a conditional statement referencing a packet or cell header type to determine if the packet or cell header in the register file is of the same type; and
in response thereto, allowing instructions in a conditional block corresponding to the conditional statement to be executed by the processing core; otherwise;
preventing the instructions in the conditional block from being executed by the processing core.

13. The method of claim 11, wherein the network processor includes a plurality of standalone compute engines, the method further comprising:
making the combined compute engine appear to the standalone compute engines as two individual compute engines.

14. A apparatus, comprising:
first and second processing cores, each including a respective datapath and register file;
a control store to store instructions;
an instruction control unit, coupled to receive instructions from the control store, to decode the instructions; and
instruction gating logic, communicately-coupled between the instruction control unit and the datapaths, to selectively forward decoded instructions received from the instruction control unit to the first and second datapaths.

15. The apparatus of claim 14, wherein the apparatus further comprises:
a thread arbiter, coupled to provide control input to the instruction control unit in response to thread event signals generated in connection with execution of a plurality of threads,
wherein the register file includes a respective set of registers for storing a context of each of the plurality of threads.

16. The apparatus of claim 14, further comprising:
first and second predicate stacks coupled to the instruction gating logic, the first and second predicate stacks to store control information used to gate flow of instructions to the first and second datapaths, respectively.

17. The apparatus of claim 16, further comprising:
control logic to generate control signals to the first and second predicate stacks, the control signals used to push datapath control information onto a predicate stack in response to evaluation of a conditional statement defining the start of a conditional block and to pop the datapath control information off of a predicate stack in response to an instruction defining an end of a conditional block.

18. The apparatus of claim 16, wherein the datapath control information comprises a logical bit indicating whether evaluation of a conditional statement is true or false for the respective datapath corresponding to the predicate stack to which the logical bit is pushed.

19. The apparatus of claim 14, further comprising:
first and second command bus controllers to provided respective command signals to functional units in the first and second datapaths, the first and second command bus controllers coupled to the instruction control unit.

20. The apparatus of claim 14, further comprising:
first and second sets of control and status registers (CSR), each CSR associated with a respective processing core, the first and second CSR coupled to the instruction control unit.

21. A network processor, comprising:
an internal interconnect comprising sets of bus lines via which data and control signals are passed;
at least one combined microengine, each combined microengine operatively-coupled to the internal interconnect and including,
first and second processing cores, each including a respective datapath and register file;
a shared control store to store instructions;
a shared instruction control unit, coupled to receive instructions from the shared control store, to decode the instructions; and
instruction gating logic, defined between the instruction control unit and the datapaths, to selectively forward decoded instructions received from the instruction control unit to the first and second datapaths; and
a least one memory controller, operatively coupled to the internal interconnect.

22. The network processor of claim 21, further comprising:
a plurality of microengines, operatively coupled to the internal interconnect.

23. The network processor of claim 21, wherein the plurality of microengines and said at least one combined microengine are configured in at least one cluster.

24. The network processor of claim 21, further comprising:
respective sets of push data and address registers and pull data and address registers included in the register file associated with each processing core;
respective push buses coupled between the respective sets of push data and address registers and said at least one memory controller; and
respective pull buses coupled between the respective sets of pull data and address registers and said at least one memory controller.

25. The network processor of claim 21, wherein each of said at least one combined microengine appear to other components on the network processor as a pair of individual microengines.

26. The network processor of claim 21, wherein each combined microengine further comprises:
first and second predicate stacks coupled to the instruction gating logic, the first and second predicate stacks to store control information used to gate flow of instructions to the first and second datapaths, respectively.

27. A network line card, comprising:
a network processor, including,
an internal interconnect comprising sets of bus lines via which data and control signals are passed;
at least one combined microengine, each combined microengine operatively-coupled to the internal interconnect and including,
first and second processing cores, each including a respective datapath and register file;
a shared control store to store instructions;
a shared instruction control unit, coupled to receive instructions from the shared control store, to decode the instructions; and
instruction gating logic, defined between the instruction control unit and the datapaths, to selectively forward decoded instructions received from the instruction control unit to the first and second datapaths;
a backplane interface including a media switch fabric interface communicatively-coupled to the internal interconnect.

28. The network line card of claim 26, wherein the network processor further includes:
a plurality of stand-alone microengines,
wherein the plurality of stand-alone microengines and said at least one microengine are configured in a least one cluster.

29. The network line card of claim 26, wherein each of said at least one combined microengine appear to other component on the network processor as a pair of stand-along microengines.

30. The network line card of claim 27, wherein each combined microengine in the network processor further includes:
first and second predicate stacks coupled to the instruction gating logic, the first and second predicate stacks to store control information used to gate flow of instructions to the first and second datapaths, respectively.
